(19) United States
(12) Patent Application Publication
(10) Pub. No.: US 2020/0314245 A1
(43) Pub. Date: Oct. 1, 2020

(54) ARTIFICIAL INTELLIGENCE DRIVEN CALL ROUTING SYSTEM

(71) Applicant: Avaya Inc., Santa Clara, CA (US)

(72) Inventors: David Chavez, Broomfield, CO (US); Laurent Philonenko, San Francisco, CA (US)

(21) Appl. No.: 16/365,122

(22) Filed: Mar. 26, 2019

(51) Int. Cl. H04M 3/523; H04M 3/51

(52) U.S. Cl. CPC H04M 3/5235; H04M 3/5175

(57) ABSTRACT

Systems, methods, software and apparatus to enable a contact center to handle a spike service requests to minimize the disruption of anomalous traffic. An Artificial Intelligence Engine enables the contact center to track, manage, maintain, assign, and route: (1) normal traffic; and (2) anomalous traffic.

### FIELD

The disclosure relates generally to contact centers and particularly to systems for routing communications and service requests in a contact center.

### BACKGROUND

A contact center manages client contacts of a business or other entity through a variety of mediums, such as telephone, fax, letter, e-mail, and online chat. Contact centers have a variety of roles that provide an all-encompassing solution to client and customer contact. Contact centers have myriad configurations. Contact centers commonly employ queues to manage service requests. For example, in skill-based queues, a work item is paired with a corresponding resource queue. When a service request is received, the service request is analyzed to determine its attributes so that the service request may be placed in the proper queue.

Similarly, contact center resources, such as contact agents, may be assigned to one or more different skills groups. When the customers contacting the contact center exceeds the number of agents available to support such customers, the customer may need to wait until an agent is available. If there is an unexpected spike in traffic, this may further increase wait times which may result in customer dissatisfaction. Despite various advancements made in contact center design, there is still room to improve efficiency that would result in higher levels of customer satisfaction through more effective routing intelligence.

### SUMMARY

A contact center will often route and queue incoming communications to a large, unsorted pool of contact center agents. These agents will have calls assigned to them based almost entirely on availability. Contact centers traditionally use static routing mechanisms for skill-based routing. For example, a contact center may have static/hard-coded set of rules to apply to customers that are assigned to the queue. The typical approach for a queue is to apply a first-in-first-out (FIFO) rule set. This approach works well for low-priority customers or simple questions that do not require a skilled agent. In general, a FIFO queue will provide a relatively efficient solution for processing incoming service requests.

Skill-based/split routing is less efficient, as it requires more agents, but offers a better quality of service and is better-suited for matching a skilled agent with a customer, and often results in more efficient, and therefore, faster handling of a service request. As can be appreciated, skill-based routing is often preferred for customers or questions that require a higher-degree of skill or training from the agent. A Vector Directory Number (VDN) in comparison, displays efficiencies in the speed of connection to an agent, but may have slower handling times because the agents are assigned without regard to skill. In some cases, a customer may need to be transferred to another agent with the skill(s) required to handle the customer's request.

Contact centers are staffed at a certain level based on established history and baselines. Attacks and unusual volume of activity can adversely affect the resources available in a contact center. In the past, leaky-bucket algorithms and other solutions could be implemented for all traffic when problems arose, but all traffic is thusly affected. Other solutions may not be effective in protecting legitimate traffic while addressing the increase in volume associated with anomalous traffic.

It is with respect to these and other needs that embodiments of the present disclosure have been contemplated. Specifically, an Artificial Intelligence (AI) routing engine is configured to analyze patterns and implement a predetermined response to handle the anomalous traffic without affecting non-anomalous (e.g., normal) traffic. Depending upon the desired performance of a particular contact center, one contact center routing engine may need to behave differently from other routing engines in other contact centers. Furthermore, a contact center routing engine that applies a single type of routing solution may face significant challenges when unexpected volumes of communications are received at the contact center for a particular skill group or for a new problem that is not related to a predefined skill group.

Embodiments of the present disclosure provide a mechanism to minimize the effect of anomalous traffic that results in a spike in contact center traffic. In some embodiments, an AI engine is provided with the ability to track, manage, maintain, assign, and route: (1) normal traffic; and (2) anomalous traffic. More specifically, the AI engine may be configured to allow the contact center to analyze and handle anomalous traffic without affecting normal traffic.

In some embodiments, the contact center includes an intelligence-supported queue that orchestrates, prioritizes, and computes the wait time for a customer of a multi-channel interaction and determines a best course of routing the service request. In some embodiments, the intelligence-supported queue may also include an administration Application Programming Interface (API) that will allow administrators and supervisors to use new data sources along with historical data to improve the performance of the contact center in a single location or across multiple locations.

In some embodiments, the configuration of the queue implements the general goals of the contact center, but the AI engine may enable the contact center to adapt to unexpected events that cause a spike or increase in request volume, or changes in goals over time. Additionally, the AI engine may be added to/layered with existing routing algorithms. As a non-limiting example, Agent 1 may be assigned to a split for a particular queue and then an “unforeseen event” occurs that results in additional incoming volume for the contact center. The contact center is not staffed to handle the increased activity related to the unforeseen event.

As can be appreciated, embodiments of the present disclosure enable a contact center to use FIFO metrics or other original routing solutions, and then supplement those solutions with an additional AI engine that intelligently responds to the occurrence of spikes in traffic or anomalous traffic.

In some embodiments, a method is provided that generally comprises:

monitoring and tracking in real-time the handling of service requests in a contact center to determine service request information and detecting an unexpected spike in service requests associated with anomalous traffic;

an Artificial Intelligence (AI) Routing Engine processing the service request information to separate normal traffic from the anomalous traffic;

determining normal routing rules for the normal traffic and special routing rules for the anomalous traffic; and

rerouting pending and incoming service requests based on the determined normal and special routing rules.

In some embodiments, a system to process and route service requests in a contact center, the system generally comprising:

a processor configured to monitor and track in real-time the handling of the service requests in the contact center to determine service request information and detect a spike in service requests associated with anomalous traffic;

the processor, comprising an Artificial Intelligence (AI) Routing Engine configured to process the service request information to separate normal traffic from the anomalous traffic;

the AI Routing Engine configured to determine normal routing rules for the normal traffic and special routing rules for the anomalous traffic; and

the processor configured to reroute pending and incoming service requests based on determined normal and special routing rules.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to, wireless, wireline, optical fiber cable, Radio Frequency (RF), etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112 Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “split” and/or “skill group” may be used interchangeably and may include any type of definition that includes, skills (e.g., agent skills). In addition, a skill group may include a broader definition that includes attributes (e.g., an attribute group), such as support (e.g., supports a specific type of communication), etc. An agent may have a particular state, such as, AVAILABLE, OFFLINE, ONLINE, etc. within a skill or different skills and such states may be dependent upon the state of the agent in another skill or queue.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1A is a block diagram of a first illustrative system 100 for processing and routing service requests in a contact center.

FIG. 1B is a block diagram of an embodiment of system 100 using an Artificial Intelligence (AI) Engine to process and route normal and anomalous traffic.

FIG. 1C is a block diagram of an embodiment of system 100 using the AI Engine to a digital system for deflection.

FIG. 1D is a block diagram of an embodiment of system 100 using the AI Engine to generate a split in order to handle anomalous traffic.

FIG. 2 is a flow diagram of a process for using the AI Engine to process and route service requests in a contact center.

FIG. 3 is a flow diagram of a process for dynamically handling anomalous traffic in a contact center.

FIG. 4 is a block diagram of a computer used to implement the AI Engine in accordance with embodiments of the present disclosure.

### DETAILED DESCRIPTION

An Artificial Intelligence (AI) engine analyzes traffic patterns for individual contact centers/businesses. After the AI engine establishes a baseline, the AI engine is able to detect anomalous traffic, including spikes of traffic to a specific business during normal operation, spikes of traffic to the specific business during off hours, spikes in traffic from new providers and/or new area codes, and traffic spikes and unusual patterns across multiple businesses and groups of businesses.

When the AI engine detects the anomalous traffic, the AI engine looks for a preconfigured procedure for how the contact center desires to handle the spike. The AI engine can implement preconfigured routing rules for the anomalous traffic. The contact center is only staffed to handle the normal traffic expected based on historical and baseline data, so the anomalous traffic must be handled with a new solution. Customers would be dissatisfied if they have to wait long periods of times in a queue.

In some embodiments, the anomalous traffic is blocked until it is determined that the traffic is legitimate. In some examples, after the anomalous traffic is determined to be legitimate, the traffic is forwarded to be connected. If the anomalous traffic is related or associated with the same or similar issues, the anomalous traffic may be diverted to a digital system for deflection. Since the volume of activity is associated with anomalous traffic, it does not matter whether the traffic is legitimate or not. In some embodiments, anomalous traffic is deflected so that not all channels, queues, and/or resources are consumed. This is especially effective for bot or non-legitimate traffic. In some embodiments, algorithms, such as a leaky-bucket algorithm, may be deployed specifically to the anomalous traffic to restrain the effect of anomalous traffic on the business or contact center. Additionally, the AI engine may look for and act on additional or unusual keywords being used in the Automatic Speech Recognition (ASR). When customers are suddenly using new or unusual keywords in automated dialogs, the AI engine may recognize the surge in new and unusual keywords as a traffic anomaly. The contact center may take a new action when the surge is detected, including but not limited to affecting routing, changing the context sent to the customers, and/or changing the destination of the deflection.

Importantly, the AI system may be invoked before a call is routed to a contact center by a servicing provider for the contact selected by the customer. In this case, the contact center can be protected against engineering constraints that may occur in attempting to service the attempts. An example would be a constrained number of trunks that are allocated to the contact center or the contact address being attempted. It is also possible that the AI sits within the contact center itself. The following embodiments are meant to address the flow of handling without constraining exactly where the AI is invoked topologically.

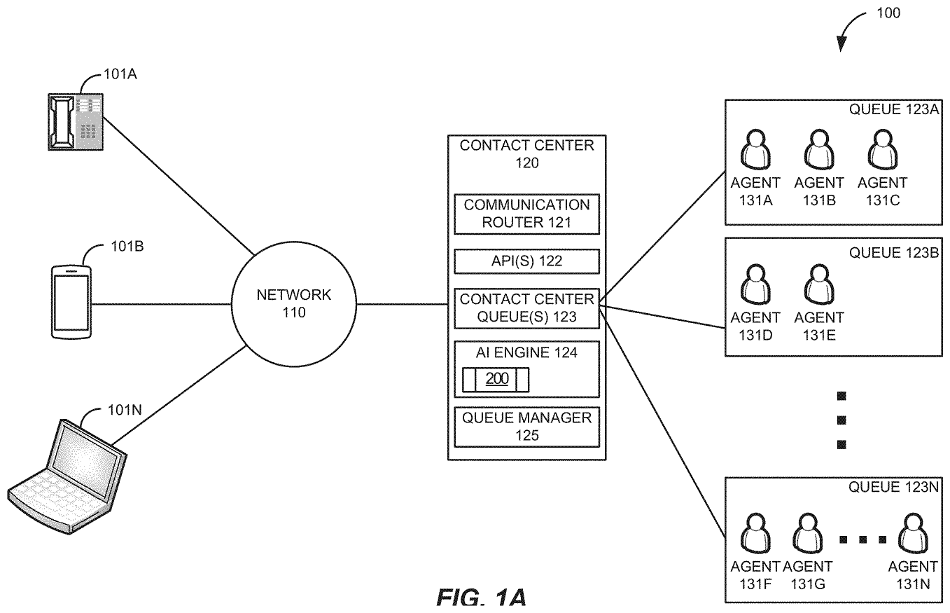

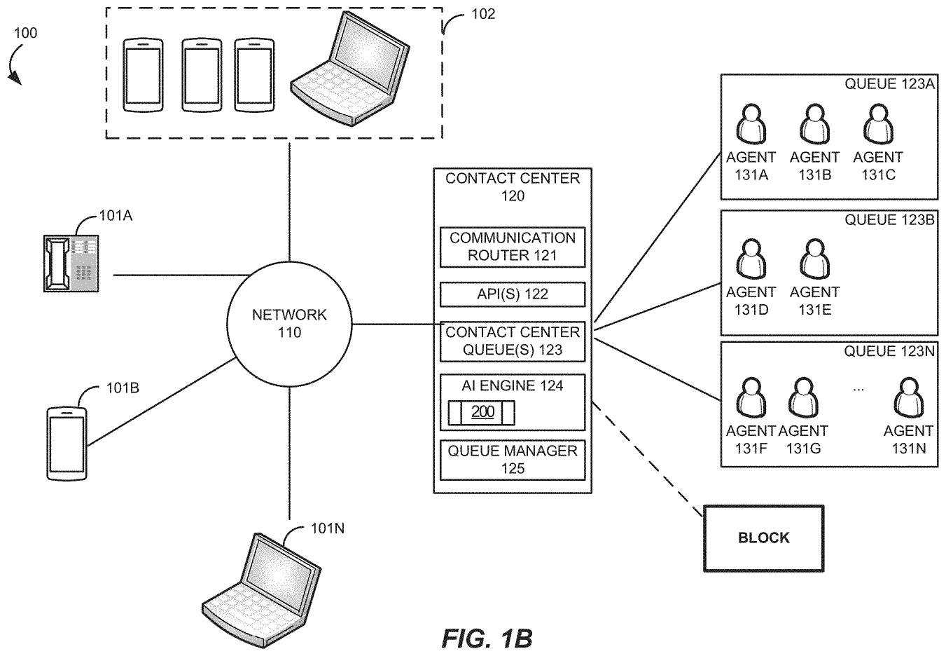

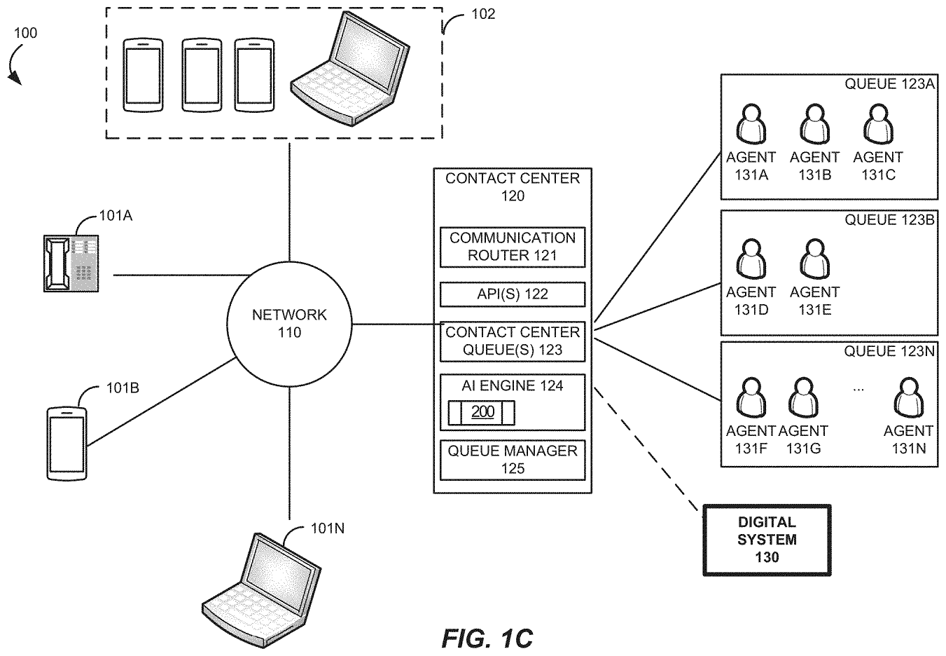

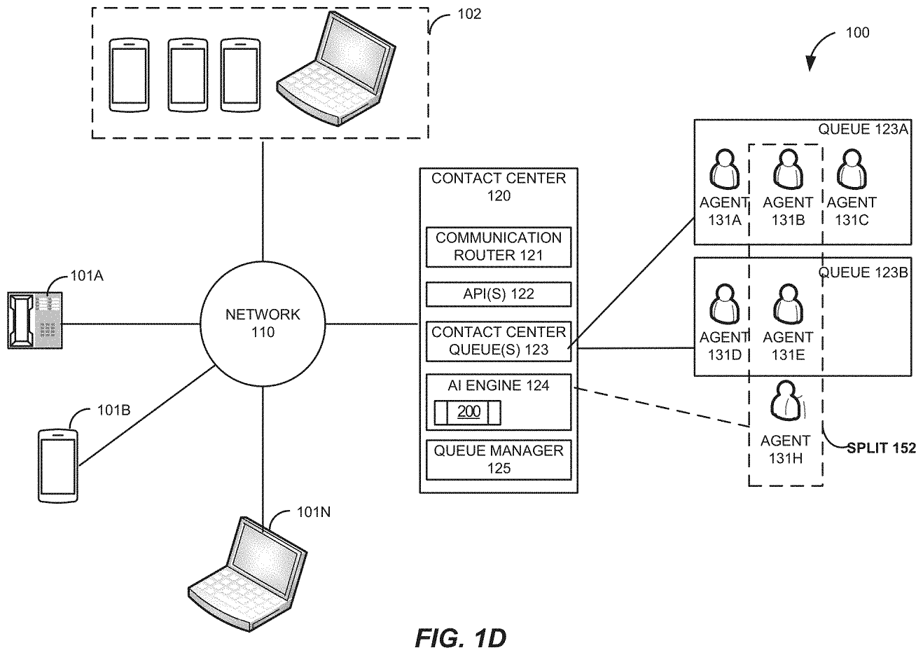

FIG. 1A is a block diagram of a first illustrative system 100 for processing and routing service requests in a contact center. Contact centers may be used to route callers, or users who seek help to an appropriate operator or agent. The first illustrative system 100 comprises communication devices 101A-N, network 110, contact center 120, and agents 131A-N in queues 123A-N. Queue 123A includes agents 131A-C, queue 123B includes agents 131D-E, and queue 123N comprises agents 131F-N. Queues are for illustrative purposes only and may include more or fewer agents than shown.

The communication devices 101A-101N can be or may include any communication device, such as a Personal Computer (PC), a telephone, a video system, a cellular telephone, a Personal Digital Assistant (PDA), a laptop, a tablet device, a notebook device, a smart phone, a wearable device, and the like. The communication devices 101A-101N are devices through which users may conduct communication sessions with contact center 120. Contact center 120 may receive service requests over multiple channels. The different channels may comprise different types of service requests (i.e. phone calls, email, chat sessions, etc.), requests received over different networks (i.e. circuit-switched, packet-switched, etc.), requests from users dialing different numbers to access the contact center, etc. Examples of communication sessions include voice calls, video calls, conference calls, VoIP calls, online chats, text messages (i.e. SMS messages), and/or other types of communication sessions. For example, device 101A may be in a circuit-switched phone call with agent 131A. In another example, device 101B may be connected with agent 131C via online chat. In yet another example, the user of device 101N may be exchanging text messages with Agent 131D.

As shown in FIG. 1A, any number of communication devices 101A-101N may be connected to the network 110. Furthermore, although only one network 110 is shown, communication devices 101A-N may connect to contact center 120 via different communication networks, such as a Public Switched Telephone Network (PSTN) and/or other circuit-switched networks, IP networks and/or other packet-switched networks.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet-switched network, a circuit-switched network, a cellular network, a combination of these, and the like. The network 110 can use a variety of electronic protocols, such as Ethernet, Internet Protocol (IP), Session Initiation Protocol (SIP), Integrated Services Digital Network (ISDN), H.323, video protocols, email protocols, cellular protocols, Instant Messaging (IM) protocol, and/or the like. Thus, the network 110 is an electronic communication network 110 configured to carry electronic messages via packets and/or circuit switched communications.

The contact center 120 can be or may include any hardware coupled with software that can manage communications (incoming and/or outgoing) that are routed to and/or from agents. The contact center 120 may comprise multiple distributed contact centers 120. For example, the contact center 120 may comprise a contact center 120 in the United States and a contact center 120 in India. Additionally, agents within a skill group may be separately located.

The contact center 120 further comprises a communication router 121, Application Program Interface(s) (APIs) 122, contact center queue(s) 123, Artificial Intelligence (AI) Engine 124, queue manager 125. The communication router 121 can be any hardware coupled with software that can route communications and/or service requests in contact center 120, such as a Private Branch Exchange (PBX), a switch, a session manager, a communication manager, a router, an email system, an instant messaging system, a text messaging system, a video switch, and/or the like. Communication router 121 can route various kinds of communications, such as voice calls, video calls, Instant Messaging (IM), text messaging, emails, virtual reality communications, and/or the like.

API(s) 122 may include an administrative API that allows administrators and/or supervisors in contact center 120 to use new algorithm or data sources to improve performance. For example, API(s) 122 may include various APIs to communicate with various social media sites, such as Linkedin®, Facebook®, Twitter®. APIs 122 may also include APIs to the weather channel or first responders. Additionally, APIs 122 may provide additional services, such as recording calls, providing additional content while customers are on hold, etc.

Contact center queue(s) 123A-N are queues for holding incoming and/or outgoing communications/service requests for contact center 120. Contact center queue(s) 123A-N can hold similar types of communications (e.g., voice calls only) or different types of communications (e.g., voice, video, text messaging, email, and/or IM communications). Contact center queue(s) 123A-N may be implemented in various manners, such as, on a first-in-first-out (FIFO) basis. In some embodiments, calls may be placed higher in contact center queues 123A-N based on various metrics. For example, a gold customer (a paying customer) may get preferential treatment over other non-paying customers by being placed higher in the contact center queue. This may be determined based on the number the customer dials to connect to contact center 120. Contact center queue(s) 123A-N may be dynamically defined to have different amounts and/or types of communications that can be held in contact center queue(s) 123A-N. For example, contact center queue 123A may be initially configured to support thirty voice calls and fifty IM chat sessions. Later, the same contact center queue 123A may be dynamically configured to support twenty-five voice calls, thirty IM sessions, and seventy-five emails. Additional agents may have been added to queue 123A in order to increase the bandwidth of the queue.

Although not shown, the contact center 120 may be implemented as a queue-less contact center 120. In a queue-less contact center 120, the communications are placed into a pool where contact center agents 131A-N may select which communications are to be worked on. In some embodiments, a queue-less contact center utilizes other means to route and prioritize the service requests.

The queues 123A-N may be created based on agents' skills, which may be associated with one or more products and/or services that are supported by the contact center agents 131A-N. For example, a first queue 123A may be created to support Company A's mobile phones, and a second queue 123B may be created to support the cellular service associated with the mobile phones. One of skill in the art could envision various combinations of contact center queue(s) 123A-N. A queue may comprise human agent(s) (e.g., contact center agents 131A-131N) and/or non-human agent(s) (e.g., an IVR system(s) automated agent(s)).

The automated agent(s) can be or may include any hardware coupled with software that can automatically respond to a communication. In some embodiments, the contact center may also include a digital system for handling requests. For example, the automated agent may respond automatically to an email based on the subject matter of the email. Alternatively, the automated agent may automatically respond to a voice communication (e.g., by using an IVR system), a video communication (e.g., by playing a video that answers the customer's questions), a prepared IM communication/SMS message, and/or the like.

In some embodiments a queue may be specific to a particular communication type. For example, a product/service may have queue for voice, video, email, IM, text messaging, and virtual reality communications. Alternatively, queues 123A-N may support all or only a portion of the supported communication types.

The queue manager 125 can be or may include any hardware coupled with software that can gather and manage information from various sources, such as the communication router 121, API(s) 122, contact center queue(s) 123, and/or the like. The queue manager 125 gathers information from various places that are relevant to the contact center's products and services.

Agents 131A-N may use terminals, which can be or may include any communication devices used by the contact center agents 131A-131N to handle incoming/outgoing communications, such as device 101A. The agent terminals may comprise multiple communication devices. For example, a contact center agent may have a telephone and a desktop computer to handle service requests for the contact center 120.

Note that any of the components of the contact center 120 may be deployed by a service provider or a cloud service provider in Network 110. It is the functional decomposition of the service that matters more than the location of the actual services. The descriptions that follow assume that these services can reside in the network even if not so explicitly stated.

FIG. 1B illustrates another embodiment of system 100 where an unexpected spike in traffic from devices 102 is received by contact center 120. In some embodiments, the spike in traffic may be associated with bot traffic. In other embodiments, the spike in traffic is legitimate, for example, if there is a new product released, then many customers may call with questions related to the new product. In another example, if there is a service outage, then service calls may increase with people trying to find out information about the outage. For example, callers may be trying to find out information on when service will be restored.

For example, AI Engine 124 may track and monitor service requests to establish a baseline for traffic. The baseline may be determined for weekdays, weekends, peak-hours, off-hours, etc. Contact center 120 uses this baseline information to determine how many agents to staff. Suddenly, traffic to contact center 120 spikes, with calls coming in from devices 102. AI Engine 124 detects the spike and processes the service requests to separate normal traffic from the anomalous traffic. AI Engine 124 may further determine if the anomalous traffic is related. AI Engine 124 further determines if there are preconfigured rules to handle anomalous traffic. How anomalous traffic is handled may be based on the determination of whether the traffic is legitimate or illegitimate. Pending and incoming requests will be rerouted based on normal and special routing rules. In some embodiments, anomalous traffic may be blocked/held until it is determined that the traffic is legitimate.

In another example, a regional bank establishes a baseline for traffic over a two-month period. Within the baseline, there is very little traffic on Sundays. On Mondays, the traffic typically starts ramping up at 8:30 AM. The regional bank staffs the call center based on the determined baselines. However, on the next Sunday, the traffic that comes in exceeds all of the traffic that normally occurs during any time of the week during normal business hours. The traffic is approximately 1000-fold more than traffic should be on a Sunday according to the established baseline and is clearly anomalous. AI Engine 124 analyzes the traffic to preemptively reroute the anomalous traffic, so that normal traffic is unaffected. This allows for the protection of the contact center resources up front.

For instance, if the anomalous traffic is coming from a 505 area code and AI Engine 124 determines the contact center has never received calls from the 505 area code, AI engine 124 may block all of the 505 calls first. The non-505 numbers go through with normal handling and are unaffected. If the 505 are determined to be legitimate business calls, the calls may be deflected to digital mechanisms for interacting (e.g., mobile web). The business is far better equipped to handle a spike in traffic using a digital system rather than having live agents handle the spike in call traffic. Service is provided with both live agents and digital mechanisms without degrading the entire contact center's resources and response times. The digital system is also capable of detecting the spike and alerting an administrator that something is going on.

FIG. 1C illustrates another embodiment of system 100 where the anomalous traffic is deflected to digital system 130.

For example, a service provider (e.g., Comcast) loses the ability to route calls for two days, including calls to the contact centers that service the service provider. People have outages at home and at their businesses and cannot call into the contact center for reporting, help, and/or updates. AI Engine 124 detects a spike in traffic and determines that routed traffic is being responded to with 404 Not Found errors and other errors. A predetermined response may be chosen by the service provider and implemented by AI engine 124.

In this case, a digital deflection may be implemented using digital system 130. Digital system 130 may alert customers immediately that there is a nationwide voice outage and provide an option to opt-in to be notified when the outage has been resolved and service restored. In some embodiments, digital system 130 may include a web chat forum, such as a social media network and/or blog site, where users can discuss an issue managed by contact center 120 to resolve a problem and/or issue. The web chat forum may be supervised by one or more contact center agents 131A-N and/or a supervisor. This proactive solution may preempt the need for customers to contact the business, thereby reducing the traffic before it occurs. Additionally, the vast majority of customers will appreciate this preemptive action during an outage of this type and magnitude.

FIG. 1D illustrates another embodiment of system 100 where the anomalous traffic is handled by creating split 152.

In some embodiments, the spike in traffic may be associated with legitimate traffic that requires live agents. Referring back to the regional bank example, the bank may implement a new feature in their online banking product, and the increased traffic may be associated with customers calling with questions related to the new feature. AI Engine 124 may track and monitor service requests to establish a baseline for traffic and contact center 120 and then use this baseline information to determine how many agents are required for staffing purposes. Suddenly, traffic to contact center 120 spikes with calls from devices 102. AI Engine 124 detects the spike and processes the service requests to separate normal traffic from the anomalous traffic. AI Engine 124 may further determine if the anomalous traffic is related to the same issue. AI Engine 124 further determines if there are preconfigured rules to handle anomalous traffic. If AI engine 124 determines that the anomalous traffic requires live agents, AI engine 124 may direct queue manager 125 to create a new queue to handle the anomalous traffic in order to minimize the impact on the normal traffic. Pending and incoming requests will be rerouted based on normal and special routing rules.

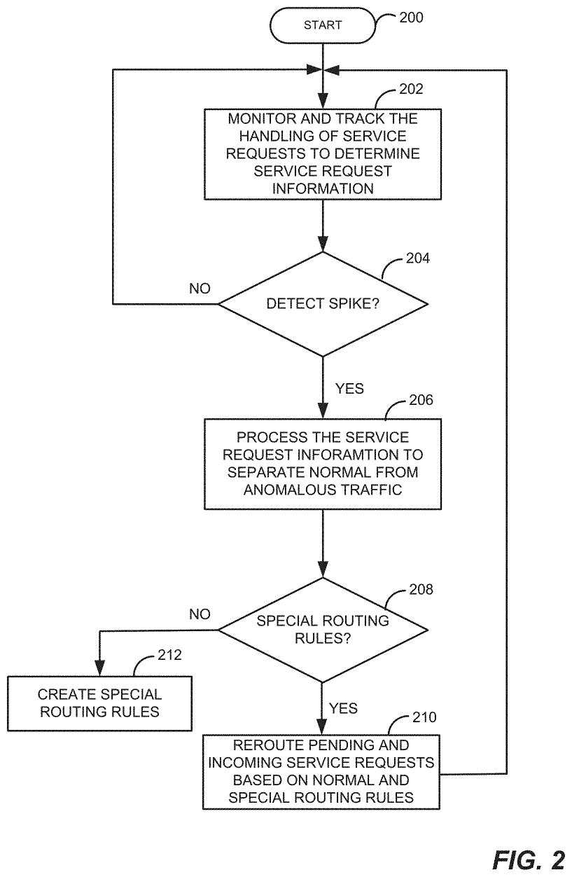

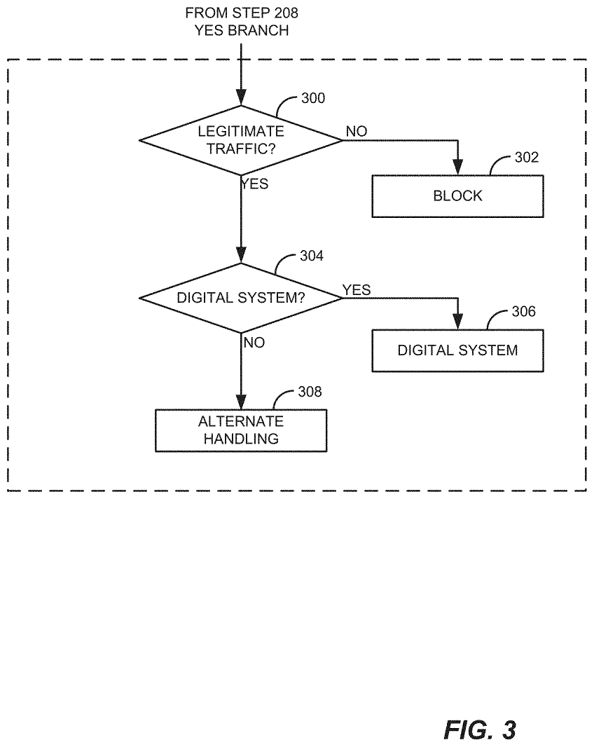

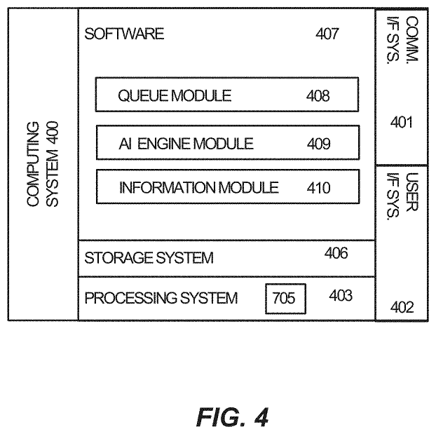

Contact center 120 may include a computer or microprocessor, as illustrated in FIG. 4, which performs the method of FIGS. 2-3 and the processes described herein by executing program instructions stored in a computer readable storage medium, such as a memory (i.e., a computer memory, a hard disk, and/or the like). Although the methods described in FIGS. 2-3 are shown in a specific order, one of skill in the art would recognize that the steps in FIGS. 2-3 may be implemented in different orders and/or be implemented in a multi-threaded environment. Moreover, various steps may be omitted or added based on implementation.

Referring to FIG. 2, which illustrates a process to intelligently manage anomalous traffic in contact center 120. The process starts in step 200. AI engine 124 monitors and tracks in real-time the handling of service requests in contact center 120 to determine service request information (step 202). Examples of service request information include calling number, type of contact, wait times, number of agents, number of available agents, average call time, number and/or type of skills groups, and/or other service request information—including combinations thereof. The service request information may be used to determine a baseline and/or average call volume for contact center 120. In some embodiments, the baseline data is used to determine staffing requirements.

AI engine 124 can gather information in various ways. For example, AI engine 124 may monitor incoming and/or outgoing communications. AI engine 124 may monitor voice, video, IM, email, text, and/or virtual reality communications for key words to identify trends that are occurring. For instance, AI engine 124 may identify that there is a specific type of problem in a newly released product serviced by contact center 120 by identifying keywords (e.g., the name of the product, the word “problem,” and the phrase “cannot configure”) in communications coming into contact center 120. The keywords may trigger an action (e.g., to reconfigure routing of communications) based on a number of keyword hits (i.e., a threshold). Alternatively, another application may identify keywords or information and then provide the information to AI engine 124.

In some embodiments, AI engine 124 may gather information from Interactive Voice Recognition (IVR) Systems. For example, AI engine may get menu selections made by callers from the IVR system(s). AI engine 124 may learn that a selection of a menu item (i.e., for a specific product) has increased 300% in the last two minutes. AI engine 124 may learn dissatisfaction of customers by monitoring a caller's voice (e.g., tone/inflection) with the IVR system and/or while the caller is on hold in a contact center queue 123A-N. AI engine 124 can determine information from gestures, facial expressions, movements, and/or the like in a video communication with a caller. AI engine 124 may use call volume, email volume, IM volume, text messaging volume, virtual reality communication volume, and/or the like. AI engine 124 may get information from contact center queue(s) 123A-N, such as the number of service requests that are currently waiting to be serviced in contact center queue(s) 123A-N. AI engine 124 may get information from the automated agents. For example, AI engine 124 may determine how many service requests are being handled by the automated agents. AI engine 124 may receive customer feedback regarding the information provided by the automated agent(s) as an input in step 202.

AI engine 124 may gather information based on feedback provided by the agents 131A-131N. As contact center agents 131A-131N manage communications in contact center 120, one or more of contact center agents 131A-N may identify a problem and may also identify a solution to the problem. This information can be sent to other contact center agents, so they can quickly resolve the problem. The information may also be sent to the automated agents so that when a customer is identified to have the same problem, the automated agent can automatically respond without having to involve a human center agent. This is one example of how contact center 120 may use an AI engine to improve performance.

AI engine 124 may gather information other sources, such as the weather system, a 911 call center, or another emergency system. For example, if the weather system indicates severe weather for a city, then AI engine 124 may use this information to dynamically reconfigure contact center 120 to handle additional incoming calls based on the weather condition, such as information regarding road closures, using a digital system.

Additionally, AI engine 124 may gather information from other sources and communication systems (not shown), such as databases (e.g., a customer history/product/service database), networking devices (e.g., a routers and/or email systems), and/or the like. AI engine 124 gathers information that is pertinent to products and/or services supported by contact center 120 to identify emerging trends. By identifying emerging trends in real-time, contact center 120 can be dynamically configured in real-time to better support the emerging trends. AI engine 124 may also alert a supervisor of the emerging trends so that the supervisor can manually make changes and/or approve the dynamic changes to contact center 120. In some embodiments, the supervisor may use APIs 122 to improve performance. For example, a new instruction that prioritizes requests related to an emerging trend may be added.

If an unexpected spike in traffic is detected (step 204), then AI engine 124 processes the service request information to separate the normal traffic from the anomalous traffic (step 206). For example, AI engine 124 may determine that the traffic spike is caused by an attack or bot traffic and separates the bot traffic from the normal/legitimate traffic. In some embodiments, the bot traffic will exercise the IVR system in deterministic and repetitive way that is inconsistent with historical traffic. This may be relatively easily discerned by the AI engine 124.

AI engine 124 may determine whether there are preconfigured rules to handle the anomalous traffic (step 208). For example, the first step may be initially block/hold any and all anomalous traffic until its legitimacy can be ascertained. Legitimacy can be ascertained if the initiator has already authenticated themselves. Additionally, the initiator may be exercising an expected flow in a customer journey that has previously been initiated. In some embodiments, once the traffic is determined to be legitimate, it may be forwarded to a digital system for handling.

AI engine reroutes pending and incoming calls based on the determined routing rules (step 210). Since some of the anomalous traffic is already in the system and queued, those service requests would need to be rerouted to handling for anomalous traffic and separated out from the normal traffic to avoid adversely affecting the normal traffic. In some embodiments, if there are no preconfigured routing rules for the anomalous traffic, AI engine 124 may intelligently route the anomalous traffic. In some examples, AI engine 124 will place the anomalous traffic is a separate queue and alert an administrator of the detected issue. In other examples, the AI engine 124 will instruct queue manager 125 to create a new queue for the requests associated with the anomalous traffic.

The above discussion describes various systems and ways that information may be captured. One of skill in the art would recognize that AI engine 124 may use various combinations of what is discussed above to dynamically reconfigure the contact center 120 to manage spikes in traffic.

In some embodiments, the anomalous traffic may be related and may be more efficiently handled by a specific skill group. For example, an unexpected software bug that was introduced by a new software patch to Product Y may cause an increased volume of calls and emails to the contact center 120 for Product Y, these calls may be handled by a new split/queue.

In some examples, AI engine 124 may reconfigure one or more menus on an IVR system. In this example, the IVR system is reconfigured to inform the caller that the contact center 120 is aware of the problem and provides automated information to the customer rather than routing the call to an agent. For example, if contact center 120 handles service requests related to Electric Company B, then during a power outage, the IVR system may play a recorded message informing customers of anticipated repair times.

FIG. 3 is a flow diagram of a process for dynamically handling anomalous traffic in contact center 120. The process of FIG. 3 is an expanded view of step 210 of FIG. 2. After determining, in step 208, that there are preconfigured routing rules (e.g., special routing rules) AI engine 124 determines, in step 300, if the anomalous traffic is legitimate or not. If the traffic is not legitimate, then the service requests are blocked (step 302). If the traffic is legitimate, then AI engine 124 determines whether the service requests should be deflected to digital system 130 (step 304). In some embodiments, the AI engine 124 may determine traffic is legitimate if the traffic is originating from random or pseudo-random IP addresses whereas the AI engine 124 may determine traffic is legitimate if the traffic is originating from a series of IP addresses having a determinable order or pattern. Other methods for determining if traffic is legitimate or not include, without limitation, cross-correlating (in time) a spike in traffic with a determined and confirmed external event, determining that a spike in traffic is similar (within a predetermined probability) to another anomalous event that occurred in the past and was confirmed as being legitimate, determining that a spike in traffic is not matching characteristics of a known brute force/DDOS/Denial of Service attack, etc. If the preconfigured routing rules indicate that the service requests should be deflected to the digital system, then the service requests are forwarded to digital system 130 for handling (step 306). If the preconfigured routing rules, do not indicate that the service requests should be deflected to a digital system, AI engine 124 determines alternate handling (step 308). For example, the traffic may be queued to be handled by live agents. In some embodiments, if one or more new queues are created to handle the anomalous traffic, the queues may be deleted once the anomalous traffic has been handled.

FIG. 4 illustrates computing system 400 used to intelligently process and route communications in a contact center as described herein, according to one implementation. Computing system 400 is representative of any computing system or systems with which the various operational architectures, processes, scenarios, and sequences disclosed herein for providing an AI routing engine in a contact center.

Computing system 400 is an example of contact center 120, although other examples may exist. Computing system 400 comprises communication interface 401, user interface 402, and processing system 403. Processing system 403 is linked to communication interface 401 and user interface 402. Processing system 403 includes a microprocessor and/or processing circuitry 405 and memory device 406 that stores operating software 407. Computing system 400 may include other well-known components such as a battery and enclosure that are not shown for clarity. Computing system 400 may comprise a server, a user device, a desktop computer, a laptop computer, a tablet computing device, or some other user communication apparatus.

Communication interface 401 comprises components that communicate over communication links, such as network cards, ports, radio frequency (RF), processing circuitry and software, or some other communication devices. Communication interface 401 may be configured to communicate over metallic, wireless, or optical links. Communication interface 401 may be configured to use Time Division Multiplex (TDM), Internet Protocol (IP), Ethernet, optical networking, wireless protocols, communication signaling, or some other communication format—including combinations thereof. In some implementations, communication interface 401 is configured to communicate with other end user devices, wherein the communication interface is used to transfer and receive voice communications for the devices. Further, communication interface 401 may interface with a webservice, wherein the service may comprise a media streaming service, gaming service, a food ordering service, online banking service, or some other similar service that can be accessed via a website.

User interface 402 comprises components that interact with a user to receive user inputs and to present media and/or information. User interface 402 may include a speaker, microphone, buttons, lights, display screen, touch screen, touch pad, scroll wheel, communication port, or some other user input/output apparatus—including combinations thereof. User interface 402 may be omitted in some examples.

Processing circuitry 405 comprises a microprocessor and other circuitry that retrieves and executes operating software 407 from memory device 406. Memory device 406 may include volatile and nonvolatile, removable and non-removable media implemented in any method or technology for storage of information, such as computer readable instructions, data structures, program modules, or other data. Memory device 406 may be implemented as a single storage device but may also be implemented across multiple storage devices or sub-systems. Memory device 406 may comprise additional elements, such as a controller to read operating software 407. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 405 is typically mounted on a circuit board that may also hold memory device 406 and portions of communication interface 401 and user interface 402. Operating software 407 comprises computer programs, firmware, or some other form of machine-readable program instructions. Operating software 407 includes modules 408-410, although any number of software modules within the application may provide the same operation. Operating software 407 may further include an operating system, utilities, drivers, network interfaces, applications, or some other type of software. When executed by processing circuitry 405, operating software 407 directs processing system 403 to operate computing system 400 as described herein.

In at least one implementation, queue module 408, when read and executed by processing system 403, directs processing system 403 to intelligently process and route service requests. AI engine module 409, when read and executed by processing system 403, directs processing system 403 to dynamically monitor and handle spikes in traffic. Information module 410, when read and executed by processing system 403, directs processing system 403 to gather information to be used to by AI engine to intelligently handle anomalous traffic as described herein.

It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network 110, such as a LAN and/or the Internet, or within a dedicated system. Thus, it should be appreciated, that the components of the system can be combined in to one or more devices or collocated on a particular node of a distributed network 110, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infrared data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of processing and routing service requests in a contact center, the method comprising:
monitoring and tracking, in real-time, handling of the service requests in the contact center to determine service request information;
detecting, based on the monitoring and tracking, an unexpected spike in service requests associated with anomalous traffic;
processing, with an Artificial Intelligence (AI) Routing Engine, the service request information to separate normal traffic from the anomalous traffic;
determining normal routing rules for the normal traffic and special routing rules for the anomalous traffic; and
rerouting pending and incoming service requests based on determined normal and special routing rules, wherein the pending service requests are already queued.

2. The method of claim 1 wherein the special routing rules comprise dynamically creating a new skill group and a queue for the new skill group and placing the service requests associated with the anomalous traffic in the queue for the new skill group.

3. The method of claim 2, further comprising:
deleting the new skill group after all the services requests in the queue for the new skill group have been handled.

4. The method of claim 1, wherein routing the special routing rules comprises modifying a skill group to create a modified skill group and creating a merged queue that includes service requests originally routed to the skill group and the service requests associated with the anomalous traffic.

5. The method of claim 4, wherein modifying the skill group to create a modified skill group comprises adding agents to the skill group.

6. The method of claim 4, further comprising:
reverting the modified skill group back to original parameters after the dynamic service request is complete.

7. The method of claim 1, wherein the spike is caused by multiple service requests associated with the same keywords.

8. The method of claim 1, wherein the spike is cause by multiple service requests associated with a detected service issue and wherein one or more of the service requests are processed via digital deflection.

9. The method of claim 1, wherein the service request information comprises at least one of current queue wait times, skills groups, available agents, and/or a priority.

10. A system to process and route service requests in a contact center, the system comprising:
a processor configured to monitor and track in real-time the handling of the service requests in the contact center to determine service request information and detect an unexpected spike in service requests associated with anomalous traffic;
an Artificial Intelligence (AI) Routing Engine, executable by the processor, configured to process the service request information to separate normal traffic from the anomalous traffic, determine normal routing rules for the normal traffic and special routing rules for the anomalous traffic and then cause the processor to reroute pending and incoming service requests based on the determined normal routing rules and the determined special routing rules, wherein the pending service requests are already in the system and queued, wherein the pending service requests are already queued.

11. The system of claim 10, wherein the processor is configured to dynamically create a new skill group and a queue for the new skill group and place the service requests associated with the anomalous traffic in the queue for the new skill group.

12. The system of claim 11, wherein the processor is further configured to delete the new skill group after all the services requests in the queue have been handled.

13. The system of claim 10, wherein the processor is configured to modify a skill group to create a modified skill group and create a merged queue that includes service requests originally routed to the skill group and the service requests associated with the anomalous traffic.

14. The system of claim 13, wherein the processor is configured to add agents to the modified skill group.

15. The system method of claim 13, wherein the processor is further configured to revert the modified skill group back to original parameters after all the services requests in the queue have been handled.

16. The system of claim 10, wherein the spike is caused by multiple service requests associated with the same keywords.

17. The system of claim 10, wherein the spike is cause by multiple service requests associated with a detected service issue.

18. The system of claim 10, wherein the service request information comprises at least one of current queue wait times, skills groups, available agents, and/or a priority.

19. A computer-readable medium device comprising processor-executable instructions comprising:
instructions configured to monitor and track in real-time the handling of the service requests in the contact center to determine service request information and detect a spike in service requests;
instructions comprising an Artificial Intelligence (AI) Routing Engine configured to process the service request information to separate normal traffic from anomalous traffic;
instructions configured to determine normal routing rules for the normal traffic and special routing rules for the anomalous traffic; and
instructions configured to reroute pending and incoming service requests based on determined normal and special routing rules, wherein the pending service requests are already in the system and queued.

20. The computer-readable medium device, wherein the spike is caused by multiple service requests associated with the same keywords.
